(19) United States
(12) Patent Application Publication
(10) Pub. No.: US 2019/0278893 A1
(43) Pub. Date: Sep. 12, 2019

(54) TACTILE STYLUS BASED AUTHENTICATION SYSTEMS AND METHODS

(71) Applicant: TRUSONA, INC., Scottsdale, AZ (US)

(72) Inventors: Ori Eisen, Scottsdale, AZ (US); Nikolas Mangu-Thitu, Lexington, KY (US)

(21) Appl. No.: 16/294,700

(22) Filed: Mar. 6, 2019

Related U.S. Application Data
(63) Continuation of application No. PCT/US2017/050208, filed on Sep. 6, 2017.
(60) Provisional application No. 62/385,008, filed on Sep. 8, 2016.

(51) Int. Cl. G06F 21/31; G06F 21/36; G06F 3/0354

(52) U.S. Cl. CPC G06F 21/316; G06F 3/03547; G06F 3/03545; G06F 21/36

(57) ABSTRACT

A method for authenticating a user is provided. The authentication method may be a multi-factor authentication method based on a token device. A tactile stylus token device may be provided. One or more tactile styluses of the token device may be moved to create contact with a touch screen of a user device during authentication. The one or more tactile styluses may be driven to generate a sequence of touching events according to a passcode. The detected touching events may be compared with the original passcode to verify an identity of the user.

### CROSS-REFERENCE TO RELATED APPLICATIONS

This application is a continuation application of PCT/US2017/050208, filed on Sep. 6, 2017, which this application claims the priority and benefit of U.S. Provisional Application No. 62/385,008 filed on Sep. 8, 2016, which applications are incorporated herein by reference in their entirety.

### BACKGROUND OF THE INVENTION

Security tokens have been used in authentication. A security token, such as a universal serial bus (USB) token or key fob may be a physical device that an authorized user of computer services is given to assist in authentication. Security tokens have been used to prove one's identity electronically. With the widespread use of the Internet, attempts to defraud people have increased. As a result, multi-factor authentication methods have been used to prevent identity theft. However, traditional methods that involve use of security tokens may require users to enter an alphanumerical string which increases burden of users during authentication.

### SUMMARY OF THE INVENTION

Accordingly, a need exists for improved systems and methods for authentication of a user identity using token based multifactor authentication techniques. Systems, apparatus and methods are provided for authentication using a tactile stylus device. The token based authentication method may involve using a tactile stylus token device in conjunction with a device having a touch screen.

In one aspect of the invention, a method for authenticating an individual is provided. The method comprises: providing a tactile stylus device having one or more tactile styluses; effecting movement of the one or more tactile styluses to generate a sequence of touching events of interacting with a touch screen of a user device, wherein the sequence of touching events are generated according to a passcode; and authenticating the individual based on the sequence of touching events detected by the user device.

In some embodiments, the sequence of touching events comprise a rhythm corresponding to the passcode. In some embodiments, a duration of each of the sequence of touching events corresponds to an element of the passcode. In some embodiments, the sequence of touching events are detected in a designated region on the touch screen. In some cases, the tactile stylus device is placed in the designated region for generating the sequence of touching events. In some cases, the designated region is pre-selected by the individual. In alternative cases, a location of the designated region varies randomly for different authentications. In some embodiments, the method further comprises collecting nonce data for authenticating the individual. In some embodiments, the method further comprises comparing the detected sequence of touching events to the passcode to authenticate the individual.

In another aspect, a device for authenticating an individual is provided. The device comprises: a control unit configured to generate a sequence of driving signals according to a passcode received by the device; and one or more tactile styluses driven by an actuation unit in response to the sequence of driving signals to generate a sequence of touching events for authenticating the individual.

In some embodiments, the one or more tactile styluses are enclosed in a housing. In some cases, the housing has a surface configured to contact a touch screen such that the sequence of touching events are detected by the touch screen when the housing contacts the touch screen.

In some embodiments, the passcode is wirelessly transmitted from a user device that has a touch screen. In some embodiments, the sequence of touching events comprises a rhythm of the one or more tactile styluses interacting with a touch screen and the rhythm corresponds to the passcode. In some embodiments, at least one of the sequence of touching events is generated by two or more styluses concurrently. In some embodiments, at least two of the sequence of touching events are generated by different styluses.

Various aspects of the invention described herein may be applied to any of the particular applications set forth below. The invention can be applied on any computing device, web service, software application, and/or security system that require user authentication and/or service provider authentication for a transaction. The invention can be implemented using hardware, or a combination of hardware or software, on one or more computing devices.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 shows an exemplary block diagram of a tactile stylus token device that may interact or communicate with a user device with touch-sensitive display screen, in accordance with embodiments of the invention

FIG. 2 illustrates an example of a tactile stylus token device performing touching activities corresponding to a passcode, in accordance with embodiments of the invention.

FIG. 3 illustrates another example of a tactile stylus token device with a touch screen, in accordance with embodiments of the invention.

FIG. 4 shows a schematic of a tactile stylus token device, in accordance with embodiments of the invention.

FIG. 5 shows examples of a user device displaying a visual representation indicating authentication region on the touch screen to accept authentication touching events, in accordance with embodiments of the invention.

FIG. 6 illustrates a schematic block diagram of exemplary components in a tactile stylus based authentication system and the communications with a user device, in accordance with some embodiments.

FIG. 7 illustrates an authentication method based on a tactile stylus token device corresponding to the system in FIG. 6.

FIG. 8 illustrates an example of multi-factor authentication method using a tactile stylus token device, in accordance with embodiments of the invention.

FIG. 9 provides examples of entities involved in an authentication event, in accordance with embodiments of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Systems and methods are provided for user authentication using token based multifactor authentication. Token based authentication method may involve using a tactile stylus token device in conjunction with a device having a touch screen. In some instances, the device having a touch screen may be a user device. System as provided may be applied as a multifactor authentication system or as a standalone token based authentication system, fraud detection system, or any transaction process that requires identity verification or authentication. The invention provides a physical token device that permits users perform authentication with ease of use. The physical token device provides a fast and convenient way for users to input tokens without manual input such that reduce the chance of errors caused by typos. The physical token device may transfer a one-time passcode token to a user device by corresponding tactile activities without requiring manually entry by users of the authentication information. The invention may also provide a one-time passcode token with resistance to replay attacks. The physical token device may be used in addition to other authentication factors such as username, password, biometrics, physical device owned by the user and the like to provide a multifactor authentication method. A passcode may comprise one or more sequence of numbers. A passcode as used herein may be referred to interchangeably as passcode token. It shall be understood that different aspects of the invention can be appreciated individually, collectively or in combination with each other.

The provided systems and methods may be used in events or activities that require user authentication or identity verification. In example, the method may be used for user authentication during transactions (such as financial transactions) with a transaction entity. Transactions may include the exchange of finances (e.g., money, notes, debt, loans, etc.). The transactions may include the exchange of goods or services. The transactions may include the exchange of information. The transactions may include user identity verification or authentication to access sensitive information or a place (e.g., buildings, power plant, etc). In some instances, the transactions may include the exchange of data that is sensitive and/or is not publicly available. A transaction entity may include any entity involved in a transaction. A transaction entity may be an individual, company, partnership, corporation, organization, group, host, or any other type of entity. In some examples transaction entities may include financial institutions (e.g., banks, financial management companies), merchants (e.g., stores, online merchants), social networking companies, non-profit organizations, health care organizations, educational institutions, governmental bodies or agencies, or any other type of entity. In some embodiments, the transaction entities may use or be a server or other type of online host. The activities and events that require user authentication may be conducted online, remotely or in person.

A tactile stylus token device may communicate with an external device to identify or authenticate a user. The external device may have a touch screen. In some embodiments, the external device may be a user device used in a transaction. The user device may allow a user to perform an online transaction, access to an account, or other activities that require authentication. Alternatively, the external device may be a public device or device provided by other parties of a transaction such as point-of-sale device that is used to verify identity of the user to conduct a transaction, access a place, and any other purposes.

The user of a tactile stylus token device may be provided for greater ease or speed of authentication of a user. For instance, when a user needs to type in a passcode, it may be time consuming and/or the user may make mistakes. The tactile stylus token device may enter the passcode in a more rapid manner and reduce the likelihood of errors. The tactile stylus token device may be capable of physically expressing a passcode in under a predetermined period of time, such as 10 seconds, 5 seconds, 3 seconds, 1 second, 0.5 seconds, or 0.1 seconds. The presence of a separate physical object from the user device may also advantageously provide an added level of security. Even if an unauthorized individual were to get ahold of the user's device, the unauthorized individual would not be authenticated without the tactile stylus token device.

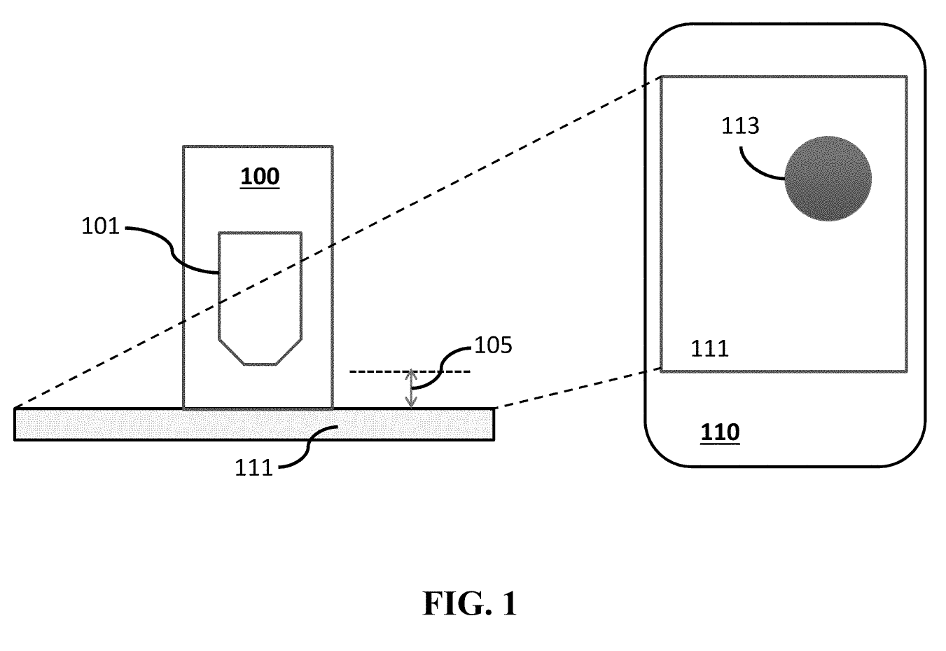

FIG. 1 shows an exemplary block diagram of a tactile stylus token device 100 interact or communicate with a user device 110 having a touch-sensitive display screen 111, in accordance with embodiments of the invention. A touch-sensitive display screen as used herein may be referred to interchangeably as a touch screen. The tactile stylus token device 100 may be physically in contact with a touch-sensitive display screen 111 of the user device 110. The tactile stylus token device 100 may be configured to receive a command signal from an authentication server to effect movement of one or more tactile stylus tips 101 to be in contact with the touch-sensitive display screen 111. In some instances, the command signal may be correlated to a sequence of one-time passcode generated by an authentication server that is used to authenticate a user. In some instances, the command signal may be an encoded, encrypted and/or hashed message of the sequence of passcode.

In some embodiments, the command signal may cause one or more tactile styluses 101 of the token device 100 to be in contact with a touch-sensitive screen 111 of the user device 110. The one or more tactile styluses may be configured to move to be in contact and not in contact with the touch-sensitive screen. The movement of the tactile styluses based on the command signal may be sensed or detected by the touch-sensitive screen and returned back to an authentication server for authentication.

A user device 110 may be, for example, one or more computing devices configured to perform one or more operations consistent with the disclosed embodiments. For example, a user device may be a computing device that is capable of executing software or applications provided by one or more authentication systems. The user device may comprise a touch-sensitive display screen 111. In some embodiments, the software and/or applications may provide to a user an image 113 on the display screen indicating an area where the token device 100 should be placed on during an authentication session. The user may be asked to place the token device 100 on the area displayed on the screen. The token device 100 may automatically move one or more tactile styluses such as up and down according to a command signal that is corresponding to a sequence of passcode. Accordingly, a sequence of tapping movements of the tactile styluses with the touch screen may be detected by the touch screen in the designated area and transmitted to an authentication server by the software and/or applications for analysis. Alternatively, the sequence of tapping movements of the tactile styluses may be detected and analyzed by the software and/or applications running on the user device 110. Then the authentication system may compare the sequence of tapping movements with the original passcode stored in a database. In some cases, the sequence of tapping movements may be converted back to a passcode (decoded) using a reverse mapping function or algorithms of the one used before. If the decoded sequence of tapping movements matches the passcode, the user may be successfully authenticated. The tactile styluses token device is designed to allow the user to enter passcode more easily, compared to the use of conventional tokens. The authentication session may be hosted by the authentication server on one or more interactive webpages, applications, or programs implemented on any device with a touch-sensitive screen, and accessed by one or more users.

A user device 110 can include, among other things, desktop computers, laptops or notebook computers, mobile devices (e.g., smart phones, cell phones, personal digital assistants (PDAs), and tablets), or wearable devices (e.g., smartwatches). A user device can also include any other media content player, for example, a set-top box, a television set, a video game system, or any electronic device capable of providing or rendering data. A user device may include known computing components, such as one or more processors, and one or more memory devices storing software instructions executed by the processor(s) and data. The user device may optionally be portable. The user device may be handheld. The user device may be a register at a store or other establishment such as entrance of a building. The register may be used during transactions (such as financial transactions) at the store or other establishments (such as to enter or access a place). The user device may be a network device capable of connecting a network, such as a local area network (LAN), wide area network (WAN) such as the Internet, a telecommunications network, a data network, or any other type of network.

The user device may comprise memory storage units which may comprise non-transitory computer readable medium comprising code, logic, or instructions for performing one or more steps. The user device may comprise one or more processors capable of executing one or more steps, for instance in accordance with the non-transitory computer readable media. The user device may comprise a display showing a graphical user interface. The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. The user device may be capable of operating one or more software applications. One or more applications may or may not be related to the operation of the tactile stylus token device.

The user device 110 may comprise a touch screen 111. The touch screen may be a touch-sensitive display screen. The touch screen 111 may allow a user to interact directly with what is displayed on the screen. A touch screen 111 may be attached to or provided as part of a desktop computer, laptop computer, tablet computer, personal digital assistant (PDA), smartphone, satellite navigation device, portable media player, portable game console, kiosk computer, point-of-sale device, or other suitable device.

The touch-sensitive touch screen 111 may provide an input interface and an output interface between the device and a user. The touch screen 111 may display visual output to the user. The visual output may include graphics, text, icons, video, and any combination thereof (collectively termed “graphics”). In some embodiments, some or all of the visual output may correspond to user-interface objects that instruct a user to place the tactile stylus token device to be in contact with a designated region, further details of which are described later.

A touch screen 111 may have a touch-sensitive surface, sensor or set of sensors that accepts input from the user based on haptic and/or tactile contact. The touch screen 111 and any associated components may detect contact (and any movement or breaking of the contact) on the touch screen 111 and converts the detected contact into interaction with user-interface objects (e.g., icons or images indicating a region to accept token device, one or more soft keys, icons, web pages or images) that are displayed on the touch screen. In some embodiments, one or more points of contact between a touch screen 111 and the tactile stylus token device corresponds to one or more styluses of the token device.

The touch screen 111 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 111.

In examples, the touch screen may be a capacitive touch screen. When an object touches or comes within proximity of the surface of the capacitive touch screen, a change in capacitance may occur within the touch screen at the location of the touch or proximity. A touch-sensor controller may process the change in capacitance to determine its position on the touch screen. The touch screen may or may not be able to tell difference between a finger and a stylus. The touch screen may or may not be able to detect multiple contacts. It should be noted various other touch screen technologies such as resistive touch screens, infrared and surface acoustic wave technologies can also be used for detecting touching events.

In some embodiments, a touching activity of the stylus 101 may correspond to an element of a passcode. In some instances, an element of a passcode may be a digital number, letter, symbol, or series of numbers, letters, and/or symbols. In some instances, a touching activity of the stylus may correspond to a signal hashed from one or more elements the passcode using a pre-determined hash function. Any description of any type of element of a passcode may apply to any other type of element.

The stylus 101 may be lowered to be in contact with or within a distance 105 to the touch screen 111 for a period of time and raised up 105 to break the contact with the touch screen. The distance 105 for a touching activity to be detected may depend on the specific touch screen technology. The distance can be, for example, 0 or less than 0.1 mm, 0.2 mm, 0.3 mm, 0.5 mm and the like. In order to break the contact with the touch screen, the stylus may be raised in a position greater than the distance 105, such as 0.1 mm, 0.2 mm, 0.3 mm, 0.5 mm, 1 mm, 2 mm, 3 mm, 5 mm and the like. The period of time of the stylus contacting the touch screen may correspond to a digital number. In some cases, the period of time of touching can be detected by a touching sensor of the touch screen. In some cases, the touch screen may be capable to measure a touching event having a duration of about 10 millisecond, 20 millisecond, 30 millisecond, 40 millisecond, 50 millisecond, 60 millisecond, 70 millisecond, 80 millisecond, 90 millisecond, 100 millisecond, 200 millisecond, 300 millisecond, 400 millisecond, 500 millisecond, 600 millisecond, 1 second, 2 second, 3 second or any durations greater than or less than any of the value. The touchscreen may be capable of measuring a touching event with a precision of any of the time values described herein.

In some embodiments, the touch screen 111 may be capable of detecting a sequence of touching events between one or more tactile styluses 101 of the token device and the touch screen. A touching event can be a result of touching activity detected by the touch screen. A touching event may include information about the amount of time one or more tactile styluses touches or contacts the touch screen, and the position of touching events relative to the touch screen. For example, when the tactile stylus 101 is in contact with or within a proximity 105 of the touch screen 111, a touch event may be created. The touch screen may output a signal correspond to the touching event duration and location. For example, the output signal may be a measurement of a capacity change that is indicative of a presence of one or more tactile styluses in contact or in proximity with the touch screen, and the duration of the capacity change as detected may correspond to the duration of a touching event. In some embodiments, the touching event duration may correspond to an element in a passcode (e.g., a number in a sequence of numbers, several numbers, an alphanumerical number, a portion of a passcode, etc). Temporal resolution of measure of touching events duration may depend on the sensitivity of the touch screen such as the clock frequency of circuitry of the touch screen, and/or sensor sensitivity.

In some embodiments, a sequence of touching events may correspond to a sequence of elements within a passcode. The sequence of touching events may be performed in response to a command signal. The command signal may be constructed of a sequence of digits correspond to a passcode. For instance, the timing or duration of each touching event and the order of the series of touching events may correspond to a sequence of digits. In some cases, the command signal may be an AC or DC signal to drive the one or more tactile styluses 101 to move to be in contact with or breaking with the touch screen. The command signal may be mapped from a passcode. For instance, a passcode consisted of a sequence of numbers such as ‘1425’ may be mapped into a command signal comprising a sequence of driving signals of 10 milliseconds, 40 milliseconds, 20 milliseconds, 50 milliseconds to drive the stylus to stay down in contact with the touch screen for 10 milliseconds, 40 milliseconds, 20 milliseconds, 50 milliseconds accordingly. It should be noted that various mapping functions or relationship can be used to transform the passcode to a command signal. The mapping may be a unique correlation such that a sequence of touching events signals can be uniquely mapped back to the original passcode. A one-to-one mapping may be provided between an element of a passcode and an individual touching event. The passcode can be various types such as alphanumerical, string, ASCII, etc. The mapping may not be one-to-one mapping. For instance, a sequence of passcodes can be hashed into any number of touching events.

In some instances, encryption techniques may be used. In this case, the command signal may be a decrypted message from the passcode. In some cases, only the authentication system and/or the tactile stylus token device can encrypt/decrypt the passcode. The mapping relationship may or may not be kept secret from other devices (e.g., user device) and entities during the transaction. For instance, the user device does not need to know the mapping method or encryption algorithm.

In some embodiments, touching events may be detected in a designated area 113. A user may be prompted to place the tactile stylus token device to the designated area to perform authentication. Details about the designated area is discussed later herein.

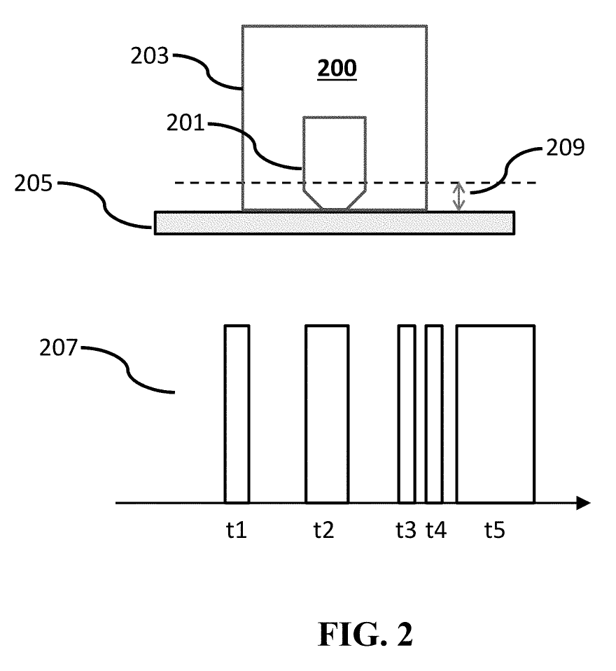

FIG. 2 illustrates an example of a tactile stylus token device 200 performing touching activities corresponding to a passcode, in accordance with embodiments of the invention. A passcode can be a sequence of numbers. A passcode can be a one-time passcode that is generated by an authentication server, the tactile stylus token device, user device, or any party involved in an authentication transaction. A passcode can be in any data type, such as alphanumeric data, ASCII, etc. A passcode once received by a tactile stylus token device may be valid for a period of time such as 1 min, 2 min, 3 min, 5 min, 10 min, 20 min, etc. The period of time may be predetermined. The period of time may or may not be selected by a user, server, or from any other party or device. An expired passcode may or may not be recycled by the authentication system.

The passcode may be mapped into a sequence of driving signals to drive the one or more tactile styluses to perform touching events. Various methods can be used to map the passcode to the command signal. For instance, the passcode can be hashed to a fixed command signal format to be used as driving signal. In this case, the passcode needs not contain the same number of elements as the command signals. For example, a passcode may be a string or a sequence of numbers containing of various length and the passcode may be uniquely mapped to a command signal with fixed number of elements. Alternatively, the passcode may comprise the same number of elements as the command signals. Each element in the passcode may correspond to duration of a touching event. In another instance, the passcode may be encrypted by an authentication server and decrypted by the tactile stylus token device before it is mapped to a command signals.

The command signal 207 may comprise a sequence of driving signals to move one or more tactile styluses 201 to be in contact with a touch screen 205. A driving signal may cause one stylus to move. A driving signal may cause multiple styluses to move concurrently. In some instances, a touching event may be detected when the stylus is lowered to be within a proximity 209 to the touch screen. The proximity 209 can be the same distance 109 as described previously. The command signal may comprise a sequence of driving signals correspond to a passcode. The command signal may cause the stylus to move with a rhythm or tempo. The rhythm or tempo may be uniquely associated with a passcode. In example, the command signal 207 comprises driving signals (e.g., t1, t2, t3, t4 and t5) to cause the tactile stylus 201 to touch the touch screen 205 for a sequence of durations (e.g., 20 milliseconds, 30 milliseconds, 10 milliseconds, 10 milliseconds, 50 milliseconds). A command signal may comprise any number of different touching durations in any combination. In some cases, each duration may represent a value corresponding to an element of the passcode. For example, a passcode comprising five digits such as 23115 may be mapped to a command signal of 20 milliseconds, 30 milliseconds, 10 milliseconds, 10 milliseconds, and 50 milliseconds. In other cases, the sequence of durations may altogether correlate to a passcode. For instance, a passcode comprising any number of elements and any value may be mapped to the format of a command signal to move the stylus accordingly. For example, a passcode may be converted to a bit string composed of long and short driving signals. The breaking time between the driving signals may or may not be a constant time. The breaking time between two consecutive driving signals may be long enough for the touch sensor to distinguish the two corresponding consecutive touching events. In some cases, a passcode may correspond to a sequence of driving signals causing one or more styluses to stay down. For example, a duration of driving signal such as tl may correspond to an element of a passcode. In other cases, a passcode may correspond to a sequence of breaking time between the driving signals which cause the one or more styluses to be raised up. For example, the breaking time between t1 and t2 may correspond to an element of a passcode. In yet other cases, a passcode may correspond to a sequence of driving signals and breaking times in any combination. For example, a combination of t1 and the breaking time after t1 may correspond to an element of a passcode.

In some embodiments, the tactile stylus 201 may be controlled to move relative to the touch screen 205. The tactile stylus 201 may be configured to move according to the driving signals 207 to perform authentication touching events. For instance, the tactile stylus 201 may stay down to be in contact with or in proximity to the touch screen for a sequence of durations (e.g., t1, t2, t3, t4, t5). The tactile stylus may or may not need to contact the touch screen in order to be detected as an authentication touching event. The authentication touching events can be performed within a short period of time such as about 0.1 second, 0.2 second, 0.3 second, 0.4 second, 0.5 second, 0.6 second, 0.7 second, 0.8 second, 0.9, second, 1 second, 2 seconds and the like. In some cases, the total time for performing authentication touching events is significantly less than the time for a user manually inputting a passcode using a keyboard.

In some embodiments, the tactile stylus 201 may be enclosed in a housing 203 of the tactile stylus token device 200 such that a user may not be adequately see or visualize the tactile stylus's 201 interaction with the touch screen 205. The housing may be made of opaque or transparent material such that a user may or may not be able to see the tactile styluses. The housing may have any three-dimensional shape such as cube, orb, cylinder, cone, semi-sphere, cuboid, triangular prism, hexagonal prism, pyramid, or various other forms. The tactile stylus may be visible from a bottom side of the tactile stylus token device. In some examples, tactile stylus token device 200 may have substantially flat surface or flat edge to be in contact with the touch screen during authentication. When the tactile stylus token device 200 is placed on the touch screen to be in contact with the touch screen, the tactile stylus 201 may be driven to stay down within a distance 209 to the touch screen such that a touching event can be detected by the touch screen, or raise up to a greater distance than the distance 209 to break the touching event. In some cases, the flat surface of the tactile stylus token device may have an opening for the tactile stylus 201 to contact the touch screen. The area of the opening may be 10%, 20%, 30%, 40%, 50%, 60%, 70%, 80%, 90% of the total area of the bottom side of the tactile stylus token device. An area of the flat surface or flat edge of the tactile stylus may be 10%, 20%, 30%, 40%, 50%, 60%, 70%, 80%, 90% of the total area of the bottom side of the tactile stylus token device. Optionally, the flat surface or flat edge may be made of material that can stick the tactile stylus token device to the touch screen or help hold the device in place during authentication. In some cases, the tactile stylus token device may use various other components or structures to help the device hold in place during authentication such as suction cups. Alternatively, the tactile stylus token device may not need to stick to the touch screen during authentication.

The contact between bottom surface of the tactile stylus token device and the touch screen may or may not be detected as a touching or contact with the touch screen. In some cases, the contact at the bottom surface and touch screen interface may not be detected such that the authentication touching events signals may have less noise. In other cases, the contact at the bottom surface and touch screen interface may be detected in order to trigger or initiate the sequence of authentication touching events.

In some embodiments, a trigger signal may be generated when the tactile stylus token device 200 is detected to be in proximity or in contact with the touch screen 205. The trigger signal may initiate the sequence of authentication touching events according to the sequence of driving signals. In some embodiments, a contact of the bottom surface of the tactile stylus token device with the touch screen may be detected. For example, one or more sensors located on the tactile stylus token device (e.g., proximity sensors, optical sensors, touch sensors, etc) may be configured to detect a contact. In another example, one or more sensors (e.g., proximity sensors, optical sensors, touch sensors, etc) located on the user device may be configured to detect the contact then a trigger signal may be sent from the user device to the tactile stylus token device. Alternatively, the trigger signal may be generated by the user press a button or a switch on the tactile stylus token device.

The tactile stylus 201 may have a contact surface composed of any suitable materials to effectively constitute a touching event. For example, the contact surface can be made of conductive material, such as conductive rubber, metal, or any material covered by a conductive layer. The contact surface may or may not be deformable or pliable. The tip of the tactile stylus 201 may have any shape such as hemispherical, conical, ring, ball point, semi-flattened sphere, disk and various other shapes that is capable of creating a coupling point that is large enough to meet a two dimensional minimum contact area that allows the touch screen to measure a contacting duration and position. In some cases, the tactile stylus 201 may be designed to have a smaller contact area than a human finger touching area such that a touching event created by the tactile stylus is distinguishable from a touch by finger. For instance, the contact area of the tactile stylus 201 may be small such that the touch screen can recognize the touching events generated by the tactile stylus 201 from touching events generated by other objects such as finger. In some cases, the tactile stylus 201 may be composed of highly conductive material to increase measurement accuracy or sensitivity of a touching event. For instance the material may be highly electrically conductive or thermally conductive. The material may be selected to be above a lower threshold in electrical or thermal conductivity, and/or below an upper threshold in electrical or thermal conductivity.

The touch screen 205 as described previously may be configured to detect the sequence of ‘on-and-off’ touching events. The touch screen may output the sequence of ‘on-and-off’ signals to an authentication system for authentication. In some cases, the output signals may be converted or mapped back to a sequence of code to be compared with the original passcode to authentication the user.

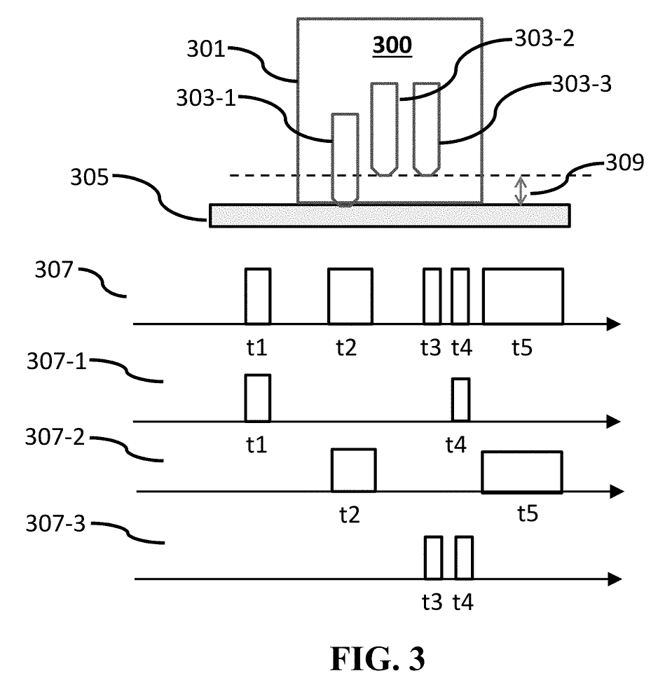

FIG. 3 illustrates another example of a tactile stylus token device with a touch screen, in accordance with embodiments of the invention. In some embodiments, the tactile stylus token device 300 may comprise a plurality of tactile styluses (303-1, 303-2, 303-3). The plurality of tactile styluses may be enclosed in a housing 301. The plurality of tactile styluses may be controlled to move close to or away from a surface of a touch screen 305 according to a command signal 307. When the tactile stylus token device is placed on the touch screen to be in contact with the touch screen, the plurality of tactile styluses may be driven to stay down within a distance 309 from the touch screen such that a touching event can be detected by the touch screen, or raise up to a greater distance than the distance 309 to break the touching event.

Each of the plurality of tactile styluses (303-1, 303-2, 303-3) can be the same tactile stylus as described in FIG. 2. A sequence of authentication touching events caused by the command signal 307 may be performed by the plurality of tactile styluses in an order instructed by the driving signals. In some cases, deployment or placement of the plurality of tactile styluses may introduce authentication information in addition to the rhythm or tempo of the authentication touching events. In some embodiments, the plurality of tactile styluses may be arranged to have a variety of relative positions. For example, the plurality of tactile styluses may be arranged in a row, a matrix, a circle and the like. In some embodiments, the relative position may be known to the authentication system such that the authentication system may be capable to recognize each touching event and corresponding tactile stylus from the detected touching events signals. For instance, the tactile styluses (303-1, 303-2, 303-3) may be arranged in a line with known positions relative to each other. In some embodiments, each individual stylus may be identified by a self-check or calibration process prior to performing the authentication touching events. For example, during a self-check process, a pre-determined self-check command may instruct the plurality of styluses to perform touching activities, as a result a position of the multiple styluses can be identified. Various other methods such as including markers, such as fiducial markers, on the tactile stylus device to be aligned with an indicator on the touch screen can be used to identify each individual stylus. The markers may be at a known location relative to each individual stylus. The markers may be visibly discernible, or may be detectable any type of sensor, such as an optical sensor, infrared sensor, ultraviolet sensor, or resistance sensor. The orientation of the token device relative to the screen may or may not matter for authentication purposes. If the orientation does matter, a self-check process and/or marker may be utilized to help verify or determine the orientation.

The plurality of styluses may perform touching activities according to a sequence of driving signals. In some cases, a driving signal may cause one stylus to move. For example, the first tactile stylus 303-1 may be caused to generate a touching event in response to driving signal t1 307-1, and the second tactile stylus 303-2 may be caused to generate a touching event in response to driving signal t2 307-2. In some cases, a driving signal may cause multiple styluses to move concurrently. For example, the tactile styluses 303-1, 303-3 may be caused to generate a touching event in response to driving signal t4 307-1, 307-3. In this case, the touching event may contain information indicating two touching locations corresponding to the first stylus 303-1 and the third stylus 303-3. In some cases, the detected touching events may contain information about relative locations of the first touching event and second touching event. The detected touching events relative positions may be compared with the known relative positions of the first tactile stylus 303-1 and the second tactile stylus 303-2 for authentication. In other embodiments, the plurality of tactile styluses may comprise different contact areas or any other suitable labels such that the touch screen can distinguish them and recognize each touching event caused by the corresponding tactile stylus. Alternatively, the plurality of tactile styluses need not be distinguishable by the touch screen or the authentication system.

The plurality of tactile styluses (303-1, 303-2, 303-3) may be driven to move sequentially or concurrently. The plurality of tactile styluses may be driven to move at a tempo or rhythm defined by a sequence of driving signals. The rhythm or tempo may be uniquely associated with a passcode. For example, a driving signal (e.g. t1) may cause one tactile stylus (e.g. 303-2) to stay down to contact the touch screen 305 for a period of time t1 whereas t2 may cause another tactile stylus (e.g., 303-3) to stay down to contact the touch screen 305 for a period of time t2. In another example, two or more tactile styluses may be controlled to contact the touch screen concurrently. For instance, tactile styluses (e.g., 303-1 and 303-2) may stay down to be in contact with the touch screen in response to the driving signal t3. Any combination of the tactile styluses may be operated to perform any sequence of authentication touching events according to the passcode or command signal. Accordingly, the touch screen may be capable to detect the sequence of authentication touching events created by the plurality of tactile styluses.

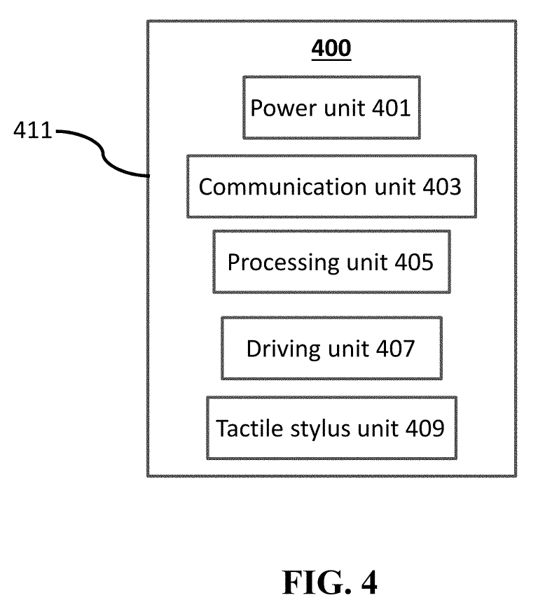

FIG. 4 schematically shows an exemplary tactile stylus token device, in accordance with embodiments of the invention. In some embodiments, the tactile stylus token device 400 may comprise a power unit 401 to provide power supply to the other components of the tactile stylus token device 400. The tactile stylus token device 400 may have a communication unit 403 to receive a command signal or passcode from an authentication system and transmit device information and instructions between a user device and the tactile stylus token device. The user device can be the same as the device 110 as described in FIG. 1. The passcode may be passed to a processing unit 405 to be converted to a sequence of driving signals. The processing unit 405 may optionally have a decryption unit. A driving unit 407 may drive a tactile stylus unit 409 to perform a sequence of authentication touching events according to the passcode or command signal. The tactile stylus token device may optionally include a memory unit for storing executable program code such as programs for calibration or self-check of the tactile stylus token device.

In some instance, the power unit 401 may be a local on-board power source such as a rechargeable battery. Any suitable charging techniques can be used such as inductive charging, contact or wireless conductive charging and the like. Alternatively, the tactile stylus token device 400 may be powered by a user device. For instance, the power may be provided through a port from the user device. Alternatively or in addition, the user device may wirelessly power the tactile stylus token device. Non-radiative or radiative wireless powering may occur. For instance, non-radiative or near-field wireless powering may occur over a short distance by use of magnetic fields (e.g., inductive charging). Radiative or far-field wireless powering may occur using power beaming, such as beams of electromagnetic radiation, such as microwaves or laser beams.

The tactile stylus token device 400 may comprise a communication unit 403. The communication unit may permit communication between the tactile stylus token device with a user device. The communication may be a wireless connection. The communication unit 403 may permit wired communications and/or wireless communications between the tactile stylus token device and any external device (e.g. user device, a server, etc).

The wireless connection may be formed between the tactile stylus token device 400 and the user device. The wireless connection may be a direct wireless connection, such as Bluetooth, infrared, Zigbee, near field communication, ultraband, WiFi, or optical communications. The wireless connection may be a short-range wireless communications may be provided (e.g., on the order of reaching at least a few centimeters, tens of centimeters, meters, or tens of meters). The wireless connection may be an indirect wireless connection, such as 3G, 4G, LTE, GSM, or WiMax. The wireless connection may traverse a telecommunications network. In some cases, the wireless communication may be formed between the tactile stylus token device and a remote authentication server. The wireless communication may permit long-range wireless communications and/or may not be dependent on relative locations between the authentication server and the tactile stylus token device. The wireless communication may traverse one or more intermediary devices or relay stations. The tactile stylus token device 400 may be configured to permit direct communications, indirect communications, or both. The tactile stylus token device 400 and/or user device may be capable of switching between different communication types.

In some cases, the wireless communications may include two-way wireless communications between the tactile stylus token and the user device. Data may flow from the user device to the tactile stylus token device and/or data may flow from the tactile stylus token device to the user device. For instance, an encrypted passcode generated by an authentication server or passcode processed by software or application provided by an authentication server may be transmitted from the user device to the tactile stylus token device. In another instance, the information transmitted from the user device to the tactile stylus token device may be instructions to set a mode of the tactile stylus token device such as calibration mode, sleep mode, etc. The tactile stylus token device may transmit information such as device status to the user device. In other cases, the wireless communications may be a one-way wireless communication. The user device may have a communication unit and/or the tactile stylus token device may have a communication unit that may permit wireless communications between the two devices. A communication unit may optionally include an antenna. In some cases, a component or dongle may be plugged into the user device that may permit the wireless communication between the user device and the tactile stylus token device. The component or dongle may include a communication unit that may communicate with a communication unit of the tactile stylus token device. In alternative embodiments, the wireless communication may be formed between the tactile stylus token device and a remote authentication server. For instance, the tactile stylus token device may receive a passcode from the authentication server directly.

In some instances, the tactile stylus token device 400 may have a form factor that may form a substantially uninterrupted surface from the user device. The tactile stylus token device may be configured to self-hold to adhere to a touching screen. Alternatively, the tactile stylus token device may be manually held against a touch screen by a user. In example, the tactile stylus token device 400 may be configured so that a bottom surface of a housing 411 of the tactile stylus token device is aligned with a touch screen surface of the user device and substantially forms a continuous surface. In another example, the bottom surface of the housing 411 may include components such as suction cups to assist holding the tactile token device in place during authentication. The tactile stylus token device 400 may have any form factor. The housing 411 may enclose the processing unit, power unit, driving unit, tactile stylus unit and/or the communication unit. Alternatively, one or more of the units may be exposed, or may be provided on an exterior portion of the housing. The housing 411 may have an opening on the bottom surface such that the tactile stylus unit may be allowed to physically contact the touch screen to create touching events. The housing 411 may have any three-dimensional shape such as cube, orb, cylinder, cone, semi-sphere, cuboid, triangular prism, hexagonal prism, pyramid, and various other forms. In some cases, the housing 411 may not allow a user adequately see or visualize the one or more tactile styluses' interactions with the touch screen. In other cases, the interaction of the tactile styluses and the touch screen may be observable to a user.

A processing unit 405 may receive digital signals passed from the communication unit 403. In some cases, the digital signals may be a passcode transmitted from a software or application provided by one or more authentication systems on the user device. The digital signals may be the same as the signals as described in FIG. 2 and FIG. 3.

The processing unit 405 may comprise one or more processors that may individually or collectively perform one or more steps. The processing unit may store the digital information in a memory unit. The memory unit may comprise one or more memory components. The processing unit may generate a sequence of driving signals based on the digital passcode or command. The processing unit may optionally include a decryption subsystem. The decryption subsystem may decrypt the passcode. The passcode may be decrypted with an encryption/decryption key. The decryption key may be stored in the memory. The decrypted passcode may be stored in the memory unit. The decrypted version or non-decrypted version of the passcode may be stored in the memory unit. The memory unit may optionally be used to store an identifier for the tactile stylus token device. The identifier for the tactile stylus token device may be unique to tactile stylus token device. The memory may store executable program codes for self-calibration or self-check of the tactile stylus token device. For instance, the executable program code may instruct the tactile stylus token device to perform calibration or self-check before an authentication.

The memory may include volatile and/or non-volatile memory. The memory may be secured by anti-tampering mechanisms. The processing unit and/or the memory unit may be implemented using a microcontroller. The microcontroller may be a secure microcontroller that may be resistant to tampering.

The processing unit may send information and/or receive information from a communication unit 403. The communication unit may include an input/output (I/O) interface. The communication unit may permit the tactile stylus token device to communicate with one or more external device, such as a user device. The communication unit may permit wired communications and/or wireless communications between the tactile stylus token device and the external device as described elsewhere herein.

A driving unit 407 may cause the tactile stylus unit 409 to move relative to a touching screen or a bottom surface of the housing 411 during authentication. The movement of the tactile styluses may or may not be perpendicular linear movement relative to the bottom surface of the housing. The movement may at least have velocity component perpendicular to the bottom surface of the housing such that the tactile styluses can be lifted off a surface of the touch screen. The driving unit 407 may comprise one or more actuators to effect a substantially linear movement of one or more styluses. The driving unit 407 may have any suitable electromechanical mechanisms (e.g., MEMS, conventional electromechanical actuators) as long as a driving force is generated to effect movement of the one or more styluses over relatively short distances during a short period of time. One or more styluses may be individually and independently actuated by the one or more actuators. In some instances, one actuator may actuate one stylus. In other instances, one actuator may actuate multiple styluses. In yet other instances, multiple actuators may actuate one stylus.

The tactile stylus unit 409 may be driven by the driving unit 407 to have movement relative to a touch screen or a bottom surface of the housing to be in contact with a touch screen during authentication. The movement as described previously may be a substantially translational movement over a short range such that one or more styluses may be controlled to stay down to reach a position (e.g., bottom surface of the housing) to be in contact with a touch screen or raise up to return back to another position that is greater than certain distance to the touch screen to break the contact with the touch screen. The tactile stylus unit 409 may comprise single tactile stylus such as the token device in FIG. 2. The tactile stylus unit 409 may comprise a plurality of tactile styluses such as the token device in FIG. 3.

In some embodiments, the tactile styluses may have passive tips such as tips comprising conductive material as described previously. In other embodiments, the tactile styluses may further comprise components such as circuitry to charge the tips in order to increase sensitivity of detection of touching events. The charged tips of the tactile styluses may be capable to create a contact with the touch screen with a higher detection sensitivity compared to a contact by finger tips.

In some embodiments, authentication touching events created by the tactile styluses may or may not be distinguishable from touching events created by fingers as sensed by the touch screen. In some cases, a variety of characteristics of the tactile styluses may be sensed by the touch screen to recognize an authentication touching event. For example, tactile styluses of the tactile stylus token device may have different conductivity, electrostatic signatures, contact area, contact duration and frequency from a finger or other tactile devices that can be recognized by the touch screen.

In some embodiments, the tactile stylus token device 400 may comprise additional sensors to detect a contact of the tactile stylus token device with the touch screen. When a contact is detected, the one or more tactile styluses may be triggered to perform the sequence of authentication touching events. A variety of sensors or technologies may be used to detect a contact such as proximity sensors, positional sensors, optical sensors, etc. Alternatively, the contact can be detected by one or more sensors of the user device then a trigger signal may be sent from the user device to the tactile stylus token device. Optionally, the authentication touching events need not be triggered by a sensor signal and various other means may be used to initiate the touching activities. For instance, a user may press a button or a switch on the tactile stylus token device 400 to initiate the authentication touching events.

The tactile stylus token device 400 may comprise additional components such as sensors to collect information about the tactile stylus token device. For example, positional information about a tactile stylus token device may be collected. The positional information about the tactile stylus token device may be used to generate a nonce data for detecting a replay attack. For example, if exact positional data (e.g., at a single point in time, or a positional profile collected over multiple points in time) is repeated for another authentication event, this may be considered suspicious, particularly when positional data is collected to a high degree of precision and/or accuracy. Similarly, if during a duration of an authentication event, a positional profile does not have any changing positions over time, this may also be suspicious or warrant further review since even if the tactile stylus token device is substantially stationary.

In some embodiments, the positional information may include an orientation of the tactile stylus token device. The orientation may be provided with respect to a static reference frame, such as an environment. The orientation may be provided with respect to a direction of gravity, and/or magnetic poles. The orientation may be determined with aid of one or more inertial sensors on tactile stylus token device. Examples of inertial sensors may include, but are not limited to, accelerometers, gyroscopes, magnetometers, or any combination thereof In some instances, a chip may be provided that may integrate one or more inertial sensors. One or more of the inertial sensors may include piezoelectric components. An inertial sensor may detect orientation with aid of a force of gravity, magnetic fields, and/or moment of inertia. The sensors and/or chips may be provided within a housing of the tactile stylus token device. The orientation of the tactile stylus token device may be determined about a single axis, two axes, or three axes. The axes may be orthogonal to one another. The axes may correspond to pitch, roll, and yaw axes of the tactile stylus token device. A single inertial sensor may be able to detect orientation with respect to any or all of the axes simultaneously, or multiple inertial sensors may be provided, each corresponding to an axis.

The orientation of tactile stylus token device may be determined to a high degree of accuracy and/or precision. In some instances, an orientation of the tactile stylus token device may be determined to within less than or equal to about 10 degrees, 5 degrees, 3 degrees, 2 degrees, 1 degree, 0.1 degrees, 0.01 degrees, 0.001 degrees, 0.0001 degrees, 0.00001 degrees, or less. The orientation may be determined with respect to each of the axes, such as each of the yaw, pitch, and roll axes of the tactile stylus token device.

Any description herein of orientation information may include static orientation information and/or dynamic orientation information. For instance, any reference to orientation information may include orientation movement information, such as angular velocity and/or angular acceleration. The angular movement information may be determined about a single axis, two axes, or three axes. The axes may be orthogonal to one another. The axes may correspond to pitch, roll, and yaw axes of the tactile stylus token device. A single inertial sensor may be able to detect orientation movement with respect to any or all of the axes simultaneously, or multiple inertial sensors may be provided, each corresponding to an axis. Angular velocity of the tactile stylus token device may be determined to a high degree of accuracy and/or precision. In some instances, an angular velocity of the tactile stylus token device may be determined to within less than or equal to about 10 degrees/s, 5 degrees/s, 3 degrees/s, 2 degrees/s, 1 degree/s, 0.1 degrees/s, 0.01 degrees/s, 0.001 degrees/s, 0.0001 degrees/s, 0.00001 degrees/s, 0.000001 degrees/s, or less. Angular acceleration of the tactile stylus token device may be determined to a high degree of accuracy and/or precision. In some instances, an angular acceleration of the tactile stylus token device may be determined to within less than or equal to about 10 degrees/s², 5 degrees/s², 3 degrees/s², 2 degrees/s², 1 degree/s², 0.1 degrees/s², 0.01 degrees/s², 0.001 degrees/s², 0.0001 degrees/s², 0.00001 degrees/s², 0.000001 degrees/s², or less. The orientation movement may be determined with respect to each of the axes, such as each of the yaw, pitch, and roll axes of the tactile stylus token device.

Positional information may or may not include spatial location information about the tactile stylus token device. For instance, coordinates relating to a spatial location of the tactile stylus token device may be determined. The spatial location may be provided with respect to a static reference frame, such as an environment. The direction of gravity and/or magnetic poles may be utilized as a reference in the static reference frame. The spatial location may be determined with aid of one or more inertial sensors, global positioning system (GPS) systems, vision sensors, reference sensors, or any combination thereof. Examples of inertial sensors may include, but are not limited to, accelerometers, gyroscopes, magnetometers, or any combination thereof In some instances, a chip may be provided that may integrate one or more inertial sensors. One or more of the inertial sensors may include piezoelectric components. An inertial sensor may detect orientation with aid of a force of gravity, magnetic fields, and/or moment of inertia. The sensors and/or chips may be provided within a housing of the tactile stylus token device. The spatial location of the tactile stylus token device may be determined along a single axis, two axes, or three axes. The axes may be orthogonal to one another. The axes may correspond to pitch, roll, and yaw axes of the tactile stylus token device. A single inertial sensor or other type of sensor may be able to detect spatial location with respect to any or all of the axes simultaneously, or multiple sensors may be provided, each corresponding to an axis.

A spatial location of a tactile stylus token device may be determined to a high degree of accuracy and/or precision. In some instances, the spatial location of the tactile stylus token device may be determined to within less than or equal to about 20 cm, 10 cm, 5 cm, 3 cm, 2 cm, 1 cm, 1 mm, 0.1 mm, 0.01 mm, 0.001 mm, 0.0001 mm, 0.00001 mm, or less. The spatial location may be determined along each of the axes, such as each of the yaw, pitch, and roll axes of the tactile stylus token device.

Any description herein of spatial location information may include static spatial location information and/or dynamic spatial location information. For instance, any reference to spatial location information may include spatial movement information, such as linear velocity and/or linear acceleration. The spatial movement information may be determined along a single axis, two axes, or three axes. The axes may be orthogonal to one another. The axes may correspond to pitch, roll, and yaw axes of the tactile stylus token device. A sensor may be able to detect orientation movement with respect to any or all of the axes simultaneously, or multiple sensors may be provided, each corresponding to an axis. Linear velocity of the tactile stylus token device may be determined to a high degree of accuracy and/or precision. In some instances, an linear velocity of the tactile stylus token device may be determined to within less than or equal to about 20 cm/s, 10 cm/s, 5 cm/s, 3 cm/s, 2 cm/s, 1 cm/s, 1 mm/s, 0.1 mm/s, 0.01 mm/s, 0.001 mm/s, 0.0001 mm/s, 0.00001 mm/s, 0.000001 mm/s, 0.0000001 mm/s, or less. Linear acceleration of the tactile stylus token device may be determined to a high degree of accuracy and/or precision. In some instances, an linear acceleration of the tactile stylus token device may be determined to within less than or equal to about 20 cm/s², 10 cm/s², 5 cm/s², 3 cm/s², 2 cm/s², 1 cm/s², 1 mm/s², 0.1 mm/s², 0.01 mm/s², 0.001 mm/s², 0.0001 mm/s², 0.00001 mm/s², 0.000001 mm/s², 0.0000001 mm/s², or less. The spatial movement may be determined with respect to each of the axes, such as each of the yaw, pitch, and roll axes of the tactile stylus token device.

Position information may include considering orientation only, spatial location only, or both orientation and spatial location (which may include static and/or dynamic information). Sensors that may aid in detection of the position information may be provided on a user device only, tactile stylus token device only, or both a user device and tactile stylus token device. In some instances, when a rigid connection is formed between the user device and tactile stylus token device, a sensor on a user device may aid in detecting positon information of the tactile stylus token device, and/or a sensor on a tactile stylus token device may aid in detecting position information of the user device. In some instances, only position of a user device may be considered, only position of a tactile stylus token device may be considered, or both a position of the user device and tactile stylus token device may be considered.

The position information may be collected at time of an authentication event. The position information may be collected when an authentication event is performed. The position information may be collected at a single instance (e.g., beginning of an authentication event, midpoint of an authentication event, end of an authentication event), or at multiple instances (e.g., every few minutes, seconds, milliseconds) or over a range of time (e.g., during an entirety of an authentication event). The timing of the collection of the position information may be determined to a high degree of accuracy and/or precision. In some instances, the timing information may be determined to within less than or equal to about 1 minute, 30 seconds, 10 seconds, 3 seconds, 2 seconds, 1 second, 0.1 seconds, 0.01 seconds, 0.001 seconds, 0.0001 seconds, 0.00001 seconds, 0.000001 seconds or less. In some instances, when position information is collected at multiple points in time (e.g., over a time range), a position profile may be created and/or stored. For instance, the position of the tactile stylus token device at a first time t1, the position of a tactile stylus token device at a second time t2, the position of a tactile stylus token device at a third time t3, and so forth may be stored as a set of data or multiple sets of data. For example, a set of positional data may appear as follows: [0.00000, (0.00000, 0.00000, 0.00000), 0.00001, (0.00120, 0.00054, −0.03012), 0.00002, (0.00278, 0.00106, −0.05045), 0.00003, (0.00415, 0.00198, −0.08398), . . . ], where the time values may be provided near positional data (angular orientation data about a pitch, yaw, and roll axis, or spatial translation data with respect to a pitch, yaw, or roll axis). The position information and/or associated timing may be stored as part of an authentication event or may be stored separately.

As previously described, if exact positional data (e.g., at a single point in time, or a positional profile collected over multiple points in time) is repeated for another authentication event, this may be considered suspicious, particularly when positional data is collected to a high degree of precision and/or accuracy. Similarly, if during a duration of an authentication event, a positional profile does not have any changing positions over time, this may also be suspicious or warrant further review since even if the tactile stylus token device is substantially stationary.

The tactile stylus token device 400 may or may not comprise a button or switch to turn on or turn off the power of the device. In some embodiments, the tactile stylus token device may include an indicator (e.g., LED, audio, display) indicating a status of the tactile stylus token device. The status may include a power level, communication connection status, data transmission status, calibration status, etc. For example, the indicator may prompt the user to place the tactile stylus token device to the touch screen of user device when a passcode is received or the expiration of a passcode.

The tactile stylus token device may communicate with a user device to perform authentication touching events. A user device may be, for example, one or more computing devices configured to perform one or more operations consistent with the disclosed embodiments. For example, a user device may be a computing device that is capable of executing software or applications provided by one or more authentication systems. In some embodiments, the software and/or applications may provide to a user a plurality of visual representations during an authentication session. The user may be asked to place the tactile stylus token device to a region on the touch screen indicated by a visual representation. The software and/or applications may transmit a passcode to the tactile stylus token device. After the authentication touching events detected by the user device in the matched region, the software and/or applications may transmit the sequence of touching events signals to an authentication server and compare the information mapped from the authentication touching events signals with the user's passcode stored in a database. If the information converted from the sequence of authentication touching events matches the passcode, the user may be successfully authenticated.

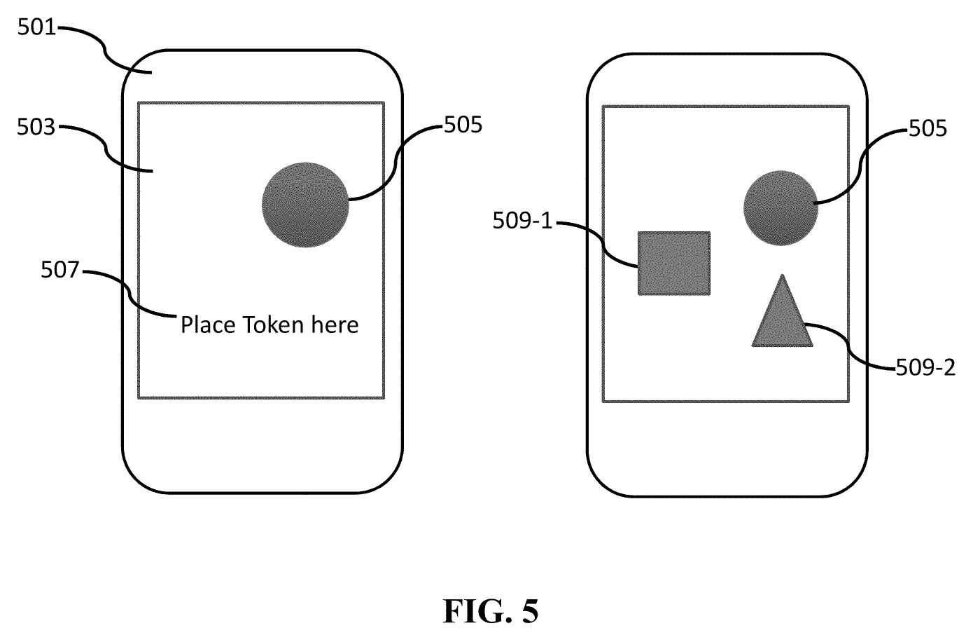

FIG. 5 shows an example of a user device 501 displaying a visual representation 505 indicating authentication region on the touch screen 503 to accept authentication touching events, in accordance with embodiments of the invention. The touch screen 503 may use a variety of display technologies to display the visual representation such as LCD (liquid crystal display) technology, or LPD (light emitting polymer display). The touch screen 503 may detect authentication touching events or contacts and breaking thereof in the authentication region as denoted by the visual representation. A variety of touch sensing technologies may be used to detect the authentication touching events, including but not limited to capacitive, resistive, infrared, surface acoustic wave technologies, as well as other proximity sensor arrays or other elements for determining one or more points of contacts with a touch screen.

The software and/or application may be configured to provide a graphical user interface (GUI) for displaying an authentication region 505 on a user device 501. A GUI is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be found in hand-held devices such as MP3 players, portable media players, gaming devices and smaller household, office and industry equipment. The GUIs may be provided in software, a software application, a web browser, etc. Links may be generated through an application programming interface (API) which is a set of routines, protocols, and tools for building software applications.

The touch screen 503 may display a visual representation 505 on the screen prompting the user to place the tactile stylus token device on that visual representation. The area and location as indicated by the visual representation 505 may be referred to as authentication region. The authentication region may vary randomly for each authentication. For example, user may be provided with authentication regions in different locations on the touch screen. The locations may be determined by an authentication system. In some cases, the locations may be randomly generated for each authentication. The location of the authentication region may refer to, for example, X, Y coordinates of the visual representation with respect to the touch screen 503. In some cases, the user device may further use various other means to prompt a user to perform authentication on an authentication region such as a text or audio message 507. In some cases, the visual representation may be displayed at a different location when a passcode is expired. In some embodiments, only the authentication touching events created by the contact of the tactile stylus token device with the touch screen in the authentication region may be detected and read as valid authentication touching events.

The visual representation 505 of the authentication region may have various graphical shapes or use various images to denote the authentication region on the touch screen. In some embodiments, during an authentication, only one visual representation may be provided to the user for performing authentication touching events. In other embodiments, user may be asked to place the tactile stylus token device on a pre-selected visual representation from a plurality of visual reorientations displayed on the touch screen. For instance, a user may pre-select a circle shape image 505 as the authentication visual representation when the user is initially registered with an authentication system. The authentication visual representation may be stored in a database. During authentication, a plurality of visual representations of different shapes 509-1, 509-2 including the pre-select shape (e.g., circle 505) may be displayed to the user. The authentication system may assess the detected authentication touching events to check if the location where the authentication touching events are detected matches the location of the pre-selected shape. It should be noted that various other characteristics of graphical element can be used as an authentication visual representation such as color, shape, image contents and the like. Optionally, no visual representation is presented to user during authentication and the user may be allowed to place the tactile stylus token device to a random region on the touch screen. The user may be able to place the tactile stylus token device at any location on the screen to effect authentication. Alternatively, the user may be required to put the tactile stylus token device at a specified location or region on the screen to effect authentication. If the user places the tactile stylus token device outside the specified location or region, the user may not be authenticated. In some cases, a user may be asked to place the tactile stylus token device to a region pre-determined by the user, such as bottom left corner of the touch screen, top left corner of the touch screen, bottom right corner of the touch screen or center of the touch screen and the like. The region to place the tactile stylus token device may or may not be visually apparent. In some instances, no visual representation is provided and the user knowledge of the region to place the token device may be an additional level of security to the authentication.

In some cases, a tactile stylus device can have random orientation during authentication. In some cases, a tactile stylus device may be placed to a visual representation in a designated orientation. For instance, the tactile stylus device may be required be aligned with a shape or indicator of the visual representation. Fiducial markers or any structures of the tactile stylus token device can be included to assist in orientation alignment.

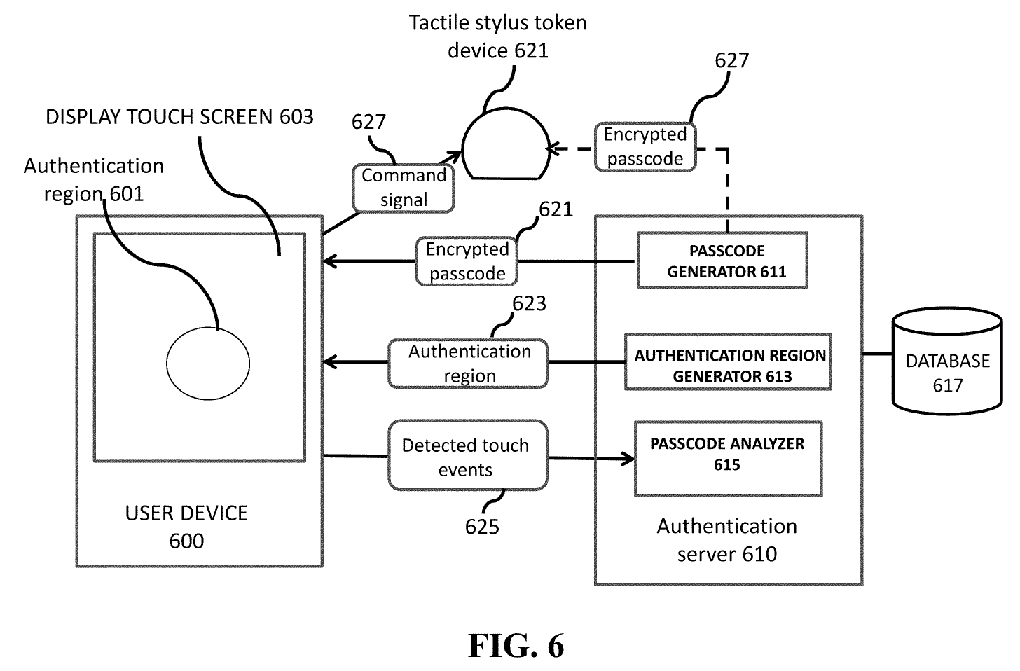

In some embodiments, the present invention provides a system for authentication based on a tactile stylus token device. FIG. 6 illustrates a schematic block diagram of exemplary components in a tactile stylus based authentication system and the communications with a user device, in accordance with some embodiments. The authentication system may comprise one or more tactile stylus token device and one or more authentication servers. The authentication system may be implemented inside and/or outside of a server. For example, the authentication system may be software and/or hardware components included with the server, or remote from the server. Although FIG. 6 illustrates the user device and the authentication system as separate components, it shall be appreciated that the authentication system can also be implemented as software and/or hardware components included with the user device. For example, passcode generation and authentication events analysis may be performed on the user device. In some instances, passcode generation may occur at the token device. Optionally, the token device may send the passcode to the server, and the server may perform the analysis by comparing the passcode from the token device, and the data from the user device about the interaction with the token device.

An authentication server 610 may comprise one or more server computers configured to perform one or more operations consistent with disclosed embodiments. In one aspect, a server may be implemented as a single computer, through which a user device is able to communicate with other components of a network layout. In some embodiments, a user device may communicate with the server through the network. In other embodiments, the server may communicate on behalf of a user device with the authentication system(s) or the database through the network. In some embodiments, the server may embody the functionality of one or more authentication system(s). In some embodiments, the authentication system(s) may be implemented inside and/or outside of the server. For example, the authentication system(s) may be software and/or hardware components included with the server or remote from the server.

In some embodiments, a user device may be directly connected to the server through a separate link. In certain embodiments, the server may be configured to operate as a front-end device configured to provide access to one or more authentication system(s) consistent with certain disclosed embodiments. The server may, in some embodiments, utilize the authentication system(s) to process input data from a user device in order to compare and match the authentication touching events signals to a pre-stored sequence of passcode for authentication purposes. The server may be configured to store the one-time passcode data in the database 617. The server may be configured to further store identification information of the user such as username, password, user selected visual representation characteristics and the like provided by the user during initial registration or long-in process. The server may also be configured to store information about the tactile stylus token device (e.g., device ID, specifications and the like) associated with the user. The server may also be configured to search, retrieve, and analyze (compare) passcode data and log-in information stored in the database. In some cases, the data and information may include a user's previous log-in attempts using the tactile stylus based token.

A server may include a web server, an enterprise server, or any other type of computer server, and can be computer programmed to accept requests (e.g., HTTP, or other protocols that can initiate data transmission) from a computing device (e.g., a user device) and to serve the computing device with requested data. In addition, a server can be a broadcasting facility, such as free-to-air, cable, satellite, and other broadcasting facility, for distributing data. A server may also be a server in a data network (e.g., a cloud computing network).

A server may include known computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods disclosed herein can be implemented in hardware components or combinations of hardware and software such as, for example, ASICs, special purpose computers, or general purpose computers. While FIG. 6 illustrates the server as a single server, in some embodiments, multiple devices may implement the functionality associated with the server.

Referring to FIG. 6, an authentication server 610 may comprise a passcode generator 611, an authentication region generator 613, and a passcode analyzer 615. The authentication system may be configured to receive user tactile stylus based authentication information from one or more users.

In some embodiments, upon receiving a request of authentication from an entity involved in a transaction, the passcode generator 611 may generate and send a unique passcode to the user device 600 interfacing the user to be authenticated. In some embodiments, the passcode may be encrypted using a variety of suitable cryptography technologies as described elsewhere herein 621. In some cases, the passcode may be valid for a limited period of time such as 2 min, 3 min, 5 min, 10 min, 20 min, 1 hour, 2 hour, etc. In some embodiments, the encrypted passcode or non-encrypted passcode may be transmitted to the user device 600 that is to be used for authentication. In some cases, a user may be requested to login a software and/or application provided by the authentication system using log-in information set up at registration with the authentication system before requesting the one-time passcode. In other embodiments, the encrypted passcode or non-encrypted passcode 627 may be transmitted to the tactile stylus token device 621 directly.

The authentication region generator 613 may randomly generate an authentication region and send the information to the user device 600. In some cases, the authentication region information may be sent along with the passcode 621. The information about the authentication region may include, but not limited to the position of the visual representation to be displayed on the touch screen (e.g, X, Y coordinates). In some cases, the authentication region generator may also determine a plurality of other graphical elements to be displayed on the touch screen in addition to the authentication visual representation as pre-determined by the user during registration. For instance, as described previously, the user may be asked to place the tactile token device to the graphical element that is pre-selected by the user among a plurality of other randomly generated graphical elements. In alternatively embodiments, the authentication region generator may not be used such that a user may place the tactile stylus token in any random locations on the touch screen.

The detected authentication touching events signals 625 can be transmitted from the user device 600 to a passcode analyzer 615. The detected touching events output signals as described previously may include information about a sequence of timing of one or multiple points of contact detected in the authentication region and location of the one or more contacts. In some cases, the output signals may also include information of the associated tactile styluses. In some embodiments, the authentication touching events signals may be transmitted to the passcode analyzer 615 via an application or software. The application or software may be provided by the authentication system and running on the user device. In some instances, the detected raw signals may be directly sent to the passcode analyzer 615. In other instances, the application or software may process the detected touching events signals (e.g. convert the signal or encrypt the data) and send the processed information to the passcode analyzer for analysis. In some embodiments, the user device identity and/or tactile stylus token device identity may be transmitted along with the authentication touching events signals or processed information as a data packet to the authentication server 610.

The passcode analyzer 615 may receive the output signals 625 from the user device and decode the signals and/or decrypt the decoded data. The passcode analyzer may compare information extracted from the output signals with historic passcode stored in the database. In some embodiments, the output signals may be processed in order to retrieve the passcode. Various steps may be applied for processing the output signals such as filter the raw data then convert the signal data to a passcode using the suitable algorithm (e.g., reverse function of the function mapping the passcode to a command signal.

In some embodiments, the passcode analyzer 615 may validate the decrypted information to verify that the sequence of touching events signals is associated with a request from an authenticated tactile stylus token device, based on the device identity (e.g., device ID) encrypted in the output signals. In another instance, the passcode analyzer may validate a timestamp of the received signal to check if the passcode is expired (e.g. shown to be validated for more than once) or contains a timestamp earlier than the timestamp in the stored copy, then a replay attack may be possible. In this case, a fraud alert may be sent to the user device, and further transactions may or may not be stopped by the authentication system.

Verification of the user by the collected data may be performed based on a matching or comparison analysis. Various factors may be checked for matching between the collected data and the original token/password data or registration data. The various factors may comprise timings of authentication touching events, locations of authentication touching events, relative positions or identities of the styluses), nonce data, time stamp and the like. In some case, the authentication touching events may need to be completely identical to the previously stored/generated passcode to be considered a match (e.g. 100% match). Alternatively, there may be some leeway in how closely the authentication touching events match. If the level of match exceeds a predetermined threshold, then the authentication touching events may be considered a match. For example, if the sequence of timing/durations of the authentication touching events signals match by more than 70%, 75%, 80%, 85%, 90%, 95%, 97%, 99%, 99.9%, 99.99%, then the authentication touching events may be considered a match. In another example, a location of the touching events may be within a designated authentication region to be considered a match. Various combinations of the factors may be used for authentication. For example, a verified match based on authentication touching events and a nonce data indicative of non-replay attack may be considered a successful authentication.

Various embodiments may exist for evaluating the match between the collected data and the original token/password data or registration data. In some examples, when the collected data from the user device matches the corresponding passcode/token or registration data, a message may be sent to the third-party transaction entity to approve the authentication. In some examples, if tactile stylus token data do not match, the authentication can be approved.

In other embodiments, the passcode analyzer may analyze the collected data to identify the user device, the tactile stylus token device or the user. In some cases, the user device may be registered as an authenticated device with the authentication system via the application or software provided by the authentication system. Alternatively, the user device can be an unauthorized device such as a public device. The tactile stylus token device may also be registered as an authenticated device with the authentication system and associated with identity of the user. For instance, during registration, a tactile stylus token device with a unique device identity may be assigned to a user identified by security tokens (e.g., passport, personal ID) authenticated by the authentication system. The user identity, associated authentication information and the associated tactile stylus token device identity information may be store in a database 617.

In some embodiments, along with the authentication touching events information, additional nonce data collected by one or more sensors of the user device and/or tactile stylus token device may be transmitted to the passcode analyzer to detect replay attack. The positional data and various other characteristics may be collected from a tactile stylus based authentication event. The positional data and other characteristics may be used for identification individually, or in combination. The positional data and other characteristics may be used for fraud detection alone, or in combination.

The user device 600 may communicate with the tactile stylus token device 621. In some embodiments, the user device 600 may send a command signal 627 converted from a passcode to the tactile stylus token device 621. Alternatively, the user device 600 may send an encrypted or non-encrypted passcode to the tactile stylus token device 621.

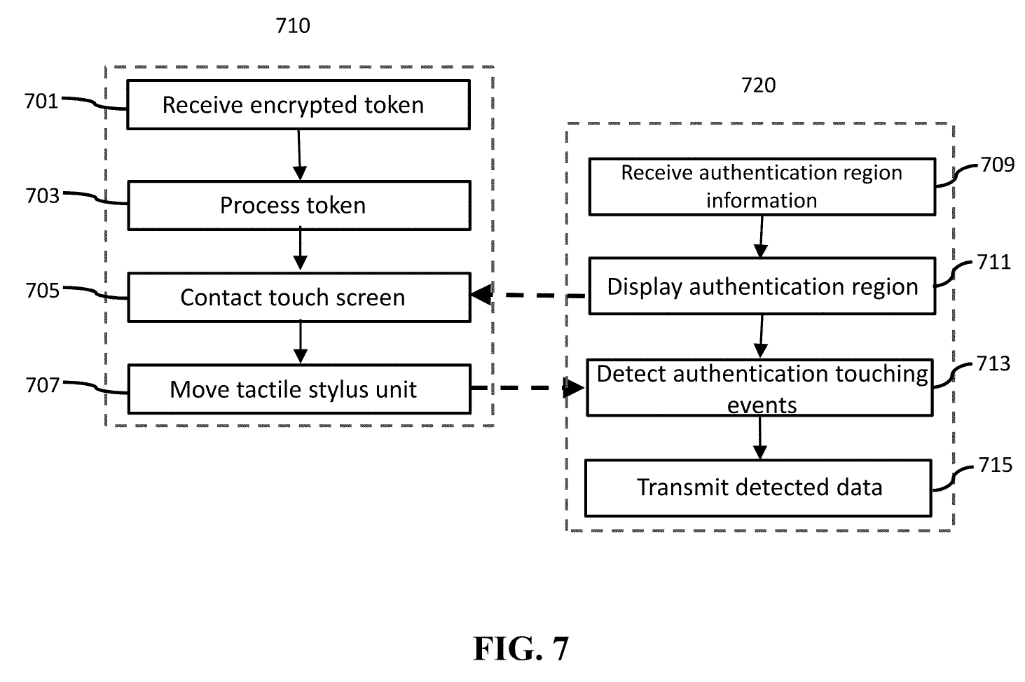

FIG. 7 illustrates an authentication method based on tactile stylus token device corresponding to the system in FIG. 6. In some embodiments, the present invention provides a method for tactile stylus based authentication. The method may comprise one or more steps performed by a tactile stylus token device 710 and one or more steps performed by a user device 720.

During an authentication, the tactile stylus token device may receive a token or passcode 701. The token or passcode may or may not be encrypted by an authentication system. The token or passcode may be a one-time passcode that may be valid for a limited range of time. The token or passcode may be processed by the tactile stylus token device to be converted to a sequence of driving signals 703. In some cases, the token or passcode may be decrypted then converted into driving signals according to any suitable mapping algorithm or method known to the authentication system. Next, the tactile stylus token device may be placed onto the touch screen in a region as indicated by the user device 705. In some cases, the contact of the tactile stylus token device with the touch screen may be detected and trigger the tactile stylus unit to perform authentication touching events according to a command signal or a sequence of driving signals 707.

During the same authentication process, the user device may receive information about the authentication region to be displayed to the user 709. The user device may display the authentication region having various characteristics (e.g., location, shape, or color) according to the information 711. Next, the touch screen of the user device may be configured to detect a sequence of authentication touching events in the authentication region 713. The detected touching events signals may be transmitted to the authentication system with or without encryption.

In some embodiments, the present invention may provide a multi-factor authentication method based on tactile stylus token device. In some embodiments, the various factors involved in the authentication method include but not limited to a user device and token device owned by the user, login or authentication information known by the user, and/or biometrics of the user. It should be noted that the present invention can be used in junction with various other authentication methods to add additional layer of security for authentication.

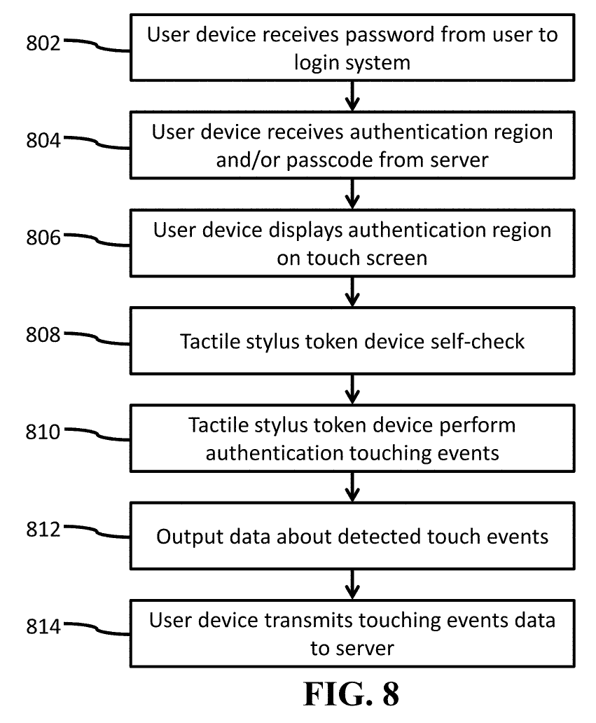

FIG. 8 illustrates an example of multi-factor authentication method, in accordance with embodiments of the invention. When authentication is required, the user device may request the user to input user credential information such as username, password, personal identification number (PIN) or biometrics data (e.g., fingerprint, voice command) to login a software or application running on the user device 802. The user credential information may be provided by the user during registration with the authentication system and stored in a database. In some embodiments, the identity of the user may be verified and authenticated by the authentication system at registration. After the user logins to the software or application, a request for authentication may be submitted from the user device or another entity involved in the transaction to an authentication server. Next, the user device may receive information about an authentication region for the tactile stylus token device to create a contact with the touch screen, and a passcode to be converted to a command signal to control the tactile stylus token device perform authentication touching events 804. The user device may transmit the passcode with or without encryption to the tactile stylus token device to be used as a command signal. Next or concurrently, the user device may display a visual representation of the authentication region on the touch screen to prompt the user place the tactile stylus token device in the region 806.

After a contact of a surface of the tactile stylus token device with the touch screen is created or detected, the tactile stylus token device may optionally perform a self-check 808. The self-check may include checking sensitivity of the touch screen, noise of the detected signals, delay or timing accuracy of the touching events, calibration of the vertical movement of the plurality of tactile styluses and the like. For instance, the one or more tactile styluses may be driven to move according to a self-checking command signal then the output signal of detected touching events is compared with the command signal to see if the measurement is accurate and correct. In some cases, the tactile stylus token device or the user device may output an alert to the user if the result does not meet a minimum requirement in terms of measurement accuracy. In this case, further adjustment or calibration may be required before proceeding with authentication. Optionally, authentication may be continued with a low level of detection reliability.

Next, the tactile stylus token device may perform authentication touching events according to the command signal or a sequence of driving signals uniquely correlated with the passcode 810. The total duration of authentication may be within a short range of time as described previously. The user device may be configured to output data about the detected authentication touching events 812. The output data may be the raw touching events signals. The output data may contain information including the duration of each touching event, location of one or multiple points of contact. The user device may transmit the data about the touching events and optionally data about the identity of the user device and/or tactile stylus token device to the authentication server for authentication 814.

In some embodiments, the tactile stylus based authentication method may comprise additional factors to increase security level. For instance, other factors such as biometrics may be required for authentication. In another example, nonce data about the user device and/or tactile stylus token device collected by one or more sensors during authentication may be used to prevent replay attack. Alternatively, the nonce data may not comprise sensor data. For example, the nonce data may be generated using the location where the tactile stylus token device touches the screen of the user device since it is highly unlikely that there is a completely identical location, particularly when the location is measured to a high degree of accuracy and/or precision. If nonce data is identically repeated in a subsequent transaction, it may raise a red flag that may indicate that the subsequent transaction is a likely replay attack, since it extremely unlikely the nonce data would repeat.

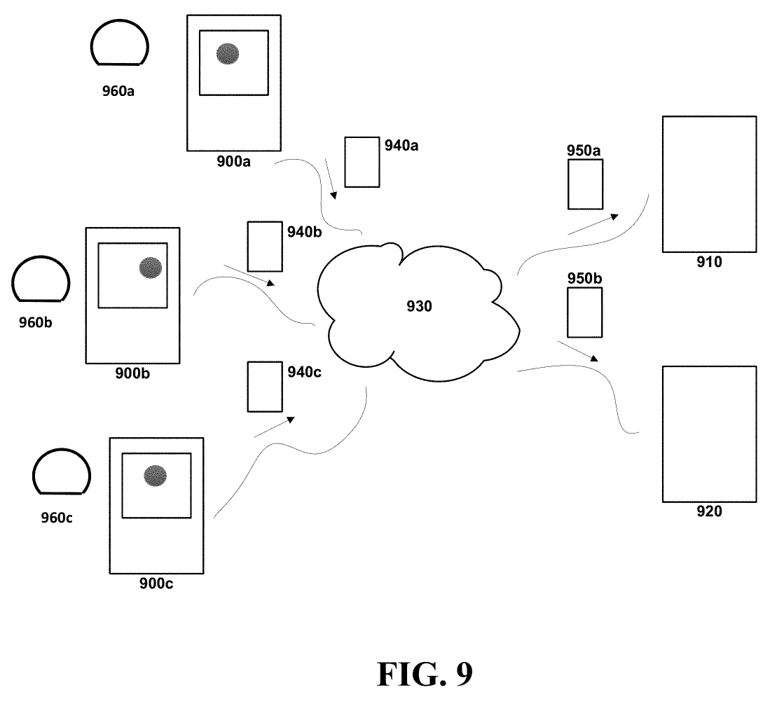

FIG. 9 provides examples of entities involved in an authentication event, in accordance with embodiments of the invention. As previously described, any type of authentication event may occur as described elsewhere herein may be used, such as various transactions. Authentications may be performed for various transactions that may or may not include the exchange of money and/or goods or services. Transactions may or may not include the exchange of information. Authentications may include any situation where a user may verify a user or user device's identity.

An authentication system may include one or more user devices 900a, 900b, 900c, 900d that may communicate with one or more external devices 910, 920. The one or more user devices may be associated with one or more respective users. Communications may occur over a network 930 or may occur directly. Tactile stylus token devices 960a, 960b, 960c may be configured to perform authentication touching events with one or more user devices and data (e.g., output signals of touching events) may be collected. Data from the one or more user devices 940a, 940b, 940c may be conveyed to the one or more external devices. In some embodiments, data received by a first external device 950a may be the same as data received by a second external device 950b, or the data may be different. In one example, a first external device may be or belong to an authentication server system (e.g., a server system configured to provide secure authentication), and/or a second external device may be or belong to one or more third parties (e.g., any transaction entity as described elsewhere herein, such as a merchant's system, a broker's system, or other entity requiring identity authentications).

The network 930 may be a communication network. The communication network(s) may include local area networks (LAN) or wide area networks (WAN), such as the Internet. The communication network(s) may comprise telecommunication network(s) including transmitters, receivers, and various communication channels (e.g., routers) for routing messages in-between. The communication network(s) may be implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocols.

The user devices 900a, 900b, 900c may include one or more characteristics of the various embodiments of the user devices described elsewhere herein. For example a user device may have one or more characteristics, components, or functions of the user device of FIG. 1. The user device may comprise a touch screen configured to detect authentication touching events created by the tactile stylus token device. In some embodiments, a user device may include one or more processors configured to handle various requests from the user, the first external device 910, and/or the second external device 920. The user device may also include or have access to one or more databases for storing various information including but not limited to, transaction information, transaction data, authentication information, identification information, financial information, account information of the user associated with the user device, device information of the user device, device identifier of tactile stylus token device(s) which may have interactions with the user device, nonce data, historic authentication data, and/or usage data associated with the user of the user device (e.g., other activity data associated with the user). Various types of user devices may be used to facilitate an authentication. An authentication system may include multiple types of user devices that may be used simultaneously.

The various types of user devices may include, but are not limited to, a handheld device, a wearable device, a mobile device, a tablet device, a laptop device, a desktop device, a computing device, a telecommunication device, a media player, a navigation device, a game console, a television, a remote control, or a combination of any two or more of these data processing devices or other data processing devices. The user device may be capable of performing a tactile stylus based authentication by having a touch screen. The user device may be configured to detect authentication touching events. Alternatively, the user device may contact or communicate with a tactile stylus token device having any of the functionality described herein.

A first external device 910 may include one or more processors. The first external device may be an authentication server system. The first external device may include or have access to one or more databases. The first external device may be in communication with one or more user devices 900a, 900b, 900c. The first external device may be in communication with various user devices with aid of a communication unit (e.g., an I/O interface). The first external device may be in communication with various transaction entity systems (e.g., merchant's system, broker's system, credit card companies, social network platforms, and/or other entities). The first external device may be in communication with various external server systems with aid of one or more I/O interfaces. The I/O interface to the user devices and/or the tactile stylus token device may facilitate the processing of input and output associated with the user devices and/or the tactile stylus token device respectively. For example, the I/O interface may facilitate the processing of a user input associated with a request for secure authentication. The I/O interface to external server systems may facilitate communications with one or more third-party entities (e.g., merchant's system, broker's system, credit card companies, social network platforms, and/or other entities).

The first external device may comprise memory storage units which may comprise non-transitory computer readable medium comprising code, logic, or instructions for performing one or more steps. The one or more processors of the first external device may be capable of executing one or more steps, for instance in accordance with the non-transitory computer readable media. In some embodiments, the one or more processors may generate or receive requests for performing secure authentications, processing the requests, comparing authentication touching events data and identification data, identifying information needed for the authentications, performing the authentications, and returning the authentication results in response to the requests. The one or more databases may store various information, including but not limited to, corresponding passcode, corresponding identification data, account information associated with each user, device information of the user device (e.g., a user device identifier), device information of the tactile stylus token device associated with the user, historic authentication data, and/or usage data associated with each user (e.g., activity data associated with each user).

The data stored about a user may include identification information about the user. The identification information may include name, data of birth, address, telephone number, gender, social security number, or any other personal information about the user.

The data stored about a tactile stylus token device may include information about the device such as the number of tactile styluses, placement of the multiple styluses, identity of the device, etc. The account information may include user's name, user's mailing address, user's telephone number, user's email address, user's birthdate, user's gender, user's social security number, user account ID and associated password, or any other personal information about the user.

Transaction related data such as nonce data may be stored. The nonce data may be associated with the user or a user device for a particular authentication event (e.g., transaction). The nonce data may be derived or may include information about conditions or parameters of the device that are extremely unlikely to repeat (e.g., chance of repetition is less than or equal to 1%, 0.5%, 0.1%, 0.05%, 0.01%, 0.005%, 0.001%, 0.0005%, 0.0001%, 0.00005%, 0.00001%, 0.000005%, or 0.000001%), individually or in combination. The nonce data may represent a singularity value for the device at that particular point in time or time interval.

The various types of information (e.g., financial information, user information, device information, and/or nonce data) may be obtained and stored in the databases of the first external device 950a during various authentication activities of the user. The first external device may have access to the databases or a subset of the databases for storing the various types of information. The various types of information may or may not also be obtained and stored during an initial registration of the user at the first external device (e.g., an authentication server system). In some embodiments, the various types of information may be accessible by the first external device. For instance, the second external device (e.g., a third-party entity) 920 may or may not be able to access the same databases or a subset of the same databases for storing the various types of information.

The second external device 920 may be or belong to a third-party entity. The third-party entity may be implemented on one or more standalone data processing apparatuses or a distributed network of computers. In some embodiments, the entity may also employ various virtual devices and/or services of third party service providers (e.g., third-party cloud service providers) to provide the underlying computing resources and/or infrastructure resources. In some embodiments, upon user's approval and in pursuance to related privacy policies, the third-party transaction entity may or may not store token device information, account information, usage data, nonce data, and/or device information associated with the user. One or more third-party transaction entities may comprise e-commerce systems, retail systems, financial institutions (e.g., banks, brokers, and credit card companies), merchant's systems, social networking platforms, and/or other entities which the user performs authentications with. In some instance, the third-party entity may be an online e-commerce, and a sequence of authentication touching events data or authentication token data may be analyzed to complete or deny a purchase of a product online. In some instance, the third-party entity may be a broker system, and authentication token data may be analyzed for verifying transfers of funds between the user's financial account and the broker system. In some instance, the third-party entity may be a social networking platform which hosts a plurality of user accounts. A user may use the authentication token data for verifying user's login to the social networking platform.

As previously described, data accessible by the first external device 950a and the second external device 950b may be the same or may differ. In some embodiments, the first external device may be an authentication system that may be capable of accessing a greater amount of data, and/or the second external device may be a third-party entity that may be capable of accessing a lesser amount of data. The first external device and the second external device may both be capable of accessing nonce data and/or any authentication event related data (e.g., transaction data). Alternatively, the first external device may be capable of obtaining the authentication token data while the second external device may not be capable of accessing the token data, or vice versa. Optionally, authentication event related data or a subset thereof may be obtained by both the first external device and/or the second external device, or by only one of the first external device or the second external device.

The external device 950a and 950b may or may not be the entities provide the one or more tactile stylus token devices 960a, 960b, 960c to the users. The external device may or may not need to encrypt/decrypt the authentication token data in order to verify or authenticate a user. In some embodiments, the external device 950a and 950b may be the entity providing a one-time passcode and an authentication region on a touch sensitive display. The authentication region may use a pre-selected visual representation such that it can be recognized only by the authentication system and the user. In some instances, only the authentication system or the authenticated application can encrypt/decrypt the authentication token data.

Data 940a, 940b, 940c from the one or more user devices may be accessible by the first external device and/or second external device, as previously described. The data from the one or more user devices may include detected authentication touching events data and identification data, and/or data about conditions or parameters of the device that may be used as nonce data. For example, for an authentication event, the user devices may send corresponding detected touching events data and/or authentication event related information. The data may be sent in response to the authentication event. The data may be pushed by the user devices or may be pulled by the first external device or the second external device. The data may be sent in real-time.

Steps for performing secure authentications may be implemented according to various embodiments. In some instances, a request for a secure authentication may be initiated from a third-party entity. In some instances, requests for authentication may be initiated at user side. In some embodiments, a user may initiate a request for a secure authentication to complete a transaction. For example, during a transaction or a login process, the user may send a user input (e.g., by pressing a button or touching a touch screen of a user device) to indicate the user's intention to initiate a secure authentication for the transaction or the login process. In some embodiments, requests for secure authentication events may be initiated from a user device. In some instances, a request for a secure authentication may be initiated from an external device, such as an authentication server system.

During initial registration of a user account with an authentication server system, the user may register for relevant account settings to require secure authentication for activities associated with this user account. During the following activities, an authentication server system may recognize a request for a transaction or a login process associated with the user account. In response to the request for the transaction, the authentication server system may send a request for a secure authentication to complete the transaction or the login process. During registration and/or the following account activities, the user may register to require authentication for all activities or some activities with certain conditions.

During initial registration of a user account with a third-party entity, the user may register for relevant account settings to require secure authentication for activities associated with this user account. For example, during initial setup of a user account to activate or manage a card on a bank's website or within the bank's application, the user may select to perform tactile stylus token device based secure authentications for one or more transactions. During the following transactions, once the third-party transaction entity recognizes a transaction associated with the user account is requested, a secure authentication is required to complete this transaction using the tactile stylus token device. During registration and/or the following account activities, the user may register to require authentication for all activities or some activities with certain conditions.

The secure authentication may require an analysis of the authentication touching events data or token data and identification data, as described elsewhere herein. The secure authentications may be required or provided as an option by an authentication server system for one or more activities. In some embodiments, the secure authentications may be required by a third-party entity. For example, a bank system or a broker system may require secure authentications to be performed to complete all or certain transactions (e.g., flagged transactions, transactions above a predetermined limit amount, or randomly selected transactions). In some instances, a secure authentication may be optional, but the third-party entity may offer rewards (e.g., cashback or bonus reward points) to the user if the user chooses to perform a secure authentication to complete the transaction.

The secure authentications may be required for all activities or some activities associated with the user account. For example, a secure authentication may be required when a transaction involves an amount of money equal to or greater than a predetermined threshold amount. For example, the predetermined threshold amount may be $100, $200, $500, $1000, $5000, $8000, $10,000, $15,000, $20,000. The threshold amount may be determined by the user, an authentication server system, or a third-party entity. In some embodiments, secure authentications may be required when the activities are identified as high risk activities. For example, the high risk activities may involve suspicious/mismatched user identity associated with the user account, suspicious transaction locations, repetitive entering of wrong user information, and/or flagged user account for previously associated fraudulent activates. In some embodiments, high risk activities may involve high speed transactions, such as requiring for funds to be transferred within a short period of time. When high speed transactions are identified, further security checks, such tactile stylus token based authentication, may be required from the user. In some instances, the use of the further authentication may allow for online activities to occur in situations where previously in-person activity was required. The further assurances of a user's identity may aid in giving entities comfort in permitting larger scale transactions.

Token data combined with identification data may be used to perform an authentication for a transaction of exchanging money, goods, and/or services with a third-party entity. For example, the user may purchase an item online from the third-party entity (e.g., an e-commerce) using a user device (e.g., a tablet or a mobile phone). The user may perform the authentication on a website or in an application associated with the third-party entity.

In one example, after selecting the desired item to purchase and entering required information for the transaction (e.g., desired quantity of the item and relevant user information), the user may be prompted to perform a secure authentication. For example, when the user wants to purchase an item priced at $1000, the user may receive a notification on the display of the user device which requires the secure authentication. The notification may require the user to place the tactile stylus token device to a designated region on the touch screen of the user device. The detected authentication touching events data may be used to verify or authenticate the user. The detected token data may be converted to the passcode format to be compared with stored passcode to confirm that the user is authenticated. In some cases, nonce data may be collected during authentication. The nonce data may be compared with historical nonce data associated with the same tactile stylus token to confirm that the nonce data is not repeating. If the nonce data is repeating, there may be further authentication checks required, or a red flag may be raised that there is a higher likelihood of a fraudulent event (e.g., replay attack). This may or may not cause the transaction to be denied or delayed.

In some other examples, the user may log into a registered user account on a website or in an application, such as a public service, an online voting system, a social networking service, etc. The user may receive a notification during the login process to perform the secure authentication, such as an identity verification. The notification may require the user to place the tactile stylus token device to a designated region on the touch screen of the user device. The detected authentication touching events data may be used to verify or authenticate the user. The detected token data may be converted to the passcode format to be compared with stored passcode to confirm that the user is authenticated. In some cases, nonce data may be collected during authentication. The nonce data may be compared with historical nonce data associated with the same tactile stylus token to confirm that the nonce data is not repeating. The identity verification may be completed if the received token data is verified and the nonce data shows no indication of fraud.

In some embodiments, the third-party entity may generate the request to perform the secure authentication per requirement of the third-party entity or per user accounting settings registered with the third-party entity. The third-party transaction entity may send the request to the user device for display. The notification may require the user to place the tactile stylus token device to a designated region on the touch screen of the user device. The detected authentication touching events data may be used to verify or authenticate the user. The detected token data may be converted to the passcode format to be compared with stored passcode to confirm that the user is authenticated. In some cases, nonce data may be collected during authentication. The nonce data may be compared with historical nonce data associated with the same tactile stylus token to confirm that the nonce data is not repeating

During a login process or any other type of authentication event, a secure authentication may be required by the authentication server system, the third-party entity, or the user. In response to the request, the user may place the tactile stylus token device to a designated region on the touch screen of the user device. The detected tactile stylus token data may be used to verify or authenticate the user. The detected tactile stylus token data may be converted to the passcode format to be compared with stored passcode to confirm that the user is authenticated. In response to the request, nonce data may be collected and/or analyzed with respect to a tactile stylus token. Nonce data combined with the detected tactile stylus token can be obtained and transmitted from the user device to the authentication server system and/or the third-party entity directly or indirectly. The user device information (e.g., user device identifier) may also be transmitted to the authentication server system and/or the third-party entity for verification.

The authentication server system may store or have access to various historic authentication information or registration information that can be used for authentication. The information may include but is not limited to, tactile stylus token device information historic nonce data, transaction data, user account information, user device identifier, or any other type of information as described elsewhere herein. The third-party entity may also store or have access to various sets of historic authentication information or registration information that can be used for authentication, such as token device information, historic nonce data, transaction data, user account information, user device identifier, or any other type of information as described elsewhere herein.

The authentication may be performed by the authentication server system solely or the third-party entity solely. In some instances, the authentication may be performed by both systems in a combined manner. For example, some information may be verified at the third-party transaction entity, such as user account information, or user device identifier. Meanwhile, other information may be verified at the authentication server system, such as tactile stylus token data.

In some instances, the third-party entity may store or have access to only user account information without having access to other confidential and/or financial information of a user, such as tactile stylus token data. Thus when an authentication with the third-party entity requires an authentication, the third-party entity may designate the authentication server system to perform an authentication. The authentication server system may then perform the authentication and return a message to the third-party transaction entity indicating whether the authentication is approved or not. The authentication server may return the message based on an analysis of tactile stylus token data for the particular authentication event. The transaction may then be approved or rejected accordingly by the third-party entity.

In some embodiments, when the analysis of the particular event does not lead to authentication, the user may be given an additional opportunity to attempt authentication. The user may be able to re-place the token device on the user device. A new passcode may be generated for each subsequent attempt at authentication. Alternatively, the passcode may be re-cycled for subsequent attempts. In some instances, the user may place the token device at the same region on a screen of the user device in subsequent attempts. Alternatively, the user may place the token device on different regions of the screen of the user device in subsequent attempts. In some instances, a user may be locked out from subsequent attempts after one or more failed attempts at authentication. The user may be required to re-calibrate or re-initialize a token device after one or more failed attempts at authentication. The token device may be removed from the screen between subsequent attempts at authentication. Alternatively, the token device may remain at the same location on the screen between subsequent attempts at authentication.

In some embodiments, the authentication server system may be optional in the authentication system. Separate third-party entities may perform any step or all steps of the authentication.

In some embodiments, the authentication server system can simultaneously perform authentication for multiple authentications for different activities. The authentication server system may simultaneously perform authentication for multiple separate third-party entities. Information stored at or accessible to the authentication server system can be collected over multiple transactions associated with various third-party entities. For example, tactile stylus token data associated with various third-party entities may be accessible by the authentication server system. This may allow intelligence gathered from multiple transactions to be used in performing the authentication. The authentication server system may have access to data repository that the third-party entities individually may not have access to.

The authentication server system and/or the third-party entity may analyze the received information, and compare the received information with the corresponding information obtained from historic authentications and/or registrations. The comparison may include comparison of tactile stylus token data and/or nonce data. The user login or transaction may be approved, rejected, or flagged as a risk authentication/login based on the comparison result. The user may be notified by the authentication server system or the third-party entity once the login or authentication is approved, rejected, or flagged.

Various embodiments may exist for evaluating the match between the collected data and the original token/password data or registration data. In some examples, when the collected data from the user device matches the corresponding passcode/token or registration data, a message may be sent to the third-party transaction entity to approve the authentication. In some examples, if tactile stylus token data do not match, the authentication can be approved. In some examples, if a user place the tactile stylus token device outside a designated authentication region, the user may receive a message prompt the user to place the token device in the correct area. In some examples, after certain times of failed authentication attempts, the authentication process may or may not proceed, or the user may or may not be able to request a new passcode.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for authenticating an individual, said method comprising:
providing a tactile stylus device having one or more tactile styluses;
effecting movement of the one or more tactile styluses to generate a sequence of touching events of interacting with a touch screen of a user device, wherein the sequence of touching events are generated according to a passcode; and
authenticating the individual based on the sequence of touching events detected by the user device.

2. The method of claim 1, wherein the sequence of touching events comprise a rhythm corresponding to the passcode.

3. The method of claim 1, wherein a duration of each of the sequence of touching events corresponds to an element of the passcode.

4. The method of claim 1, wherein the sequence of touching events are detected in a designated region on the touch screen.

5. The method of claim 4, wherein the tactile stylus device is placed in the designated region for generating the sequence of touching events.

6. The method of claim 4, wherein the designated region is pre-selected by the individual.

7. The method of claim 4, wherein a location of the designated region varies randomly for different authentications.

8. The method of claim 1, further comprising collecting nonce data for authenticating the individual.

9. The method of claim 1, further comprising comparing the detected sequence of touching events to the passcode to authenticate the individual.

10. A device for authenticating an individual comprising:
a control unit configured to generate a sequence of driving signals according to a passcode received by the device; and
one or more tactile styluses driven by an actuation unit in response to the sequence of driving signals to generate a sequence of touching events for authenticating the individual.

11. The device of claim 10, wherein the one or more tactile styluses are enclosed in a housing.

12. The device of claim 11, wherein the housing has a surface configured to contact a touch screen.

13. The device of claim 12, wherein the sequence of touching events are detected by the touch screen when the housing contacts the touch screen.

14. The device of claim 10, wherein the passcode is wirelessly transmitted from a user device that has a touch screen.

15. The device of claim 10, wherein the sequence of touching events comprises a rhythm of the one or more tactile styluses interacting with a touch screen.

16. The device of claim 15, wherein the rhythm corresponds to the passcode.

17. The device of claim 10, wherein at least one of the sequence of touching events is generated by two or more styluses concurrently.

18. The device of claim 10, wherein at least two of the sequence of touching events are generated by different styluses.

19. The device of claim 10, wherein the sequence of touching events is detected and compared to the passcode for authenticating the individual.

20. The device of claim 10, wherein the sequence of driving signals is generated from the passcode according to a pre-determined mapping relationship.
